(19) United States
(12) Patent Application Publication
(10) Pub. No.: US 2019/0063091 A1
(43) Pub. Date: Feb. 28, 2019

(54) DOOR AND WALL STRUCTURE

(71) Applicant: Framery Oy, Tamperefi (FI)

(72) Inventors: Janne HAVERI, Tampere (FI); Samu HÄLLFORS, Tampere (FI); Mikko TAMMINEN, Tampere (FI); Pekka TOIVOLA, Tampere (FI)

(21) Appl. No.: 16/073,868

(22) PCT Filed: Jan. 30, 2017
(86) PCT No.: PCT/FI2017/050052

§ 371 Date: Jul. 30, 2018

(30) Foreign Application Priority Data
Feb. 5, 2016 (FI) 20165082

(51) Int. Cl. E04H 1/14; E06B 5/20; E06B 3/02; E04B 1/82; E04B 1/86

(52) U.S. Cl. CPC E04H 1/14; E06B 5/20; E04B 1/86; E04B 1/8218; E06B 3/02

(57) ABSTRACT

A structure includes a body element and a surface plate attached to the body element. The surface element includes a substantially transparent material. The surface plate also includes on a portion thereof contacting the body element a colored surface layer.

### TECHNICAL FIELD

The present application generally relates to door and wall structures. In particular, but not exclusively, the present application relates to soundproof glass door and wall structures.

### BACKGROUND

This section illustrates useful background information without admission of any technique described herein being representative of the state of the art.

Walls and doors made of glass are often esthetically pleasing to behold and practical in other ways as well. However, in spaces requiring sturdier structures and/or soundproofing or dampening of sound, glass walls and doors with the desired look have so far been difficult to build.

Soundproofing and structurally reinforcing arrangements, for example in phone booths, conference rooms, inner or outer walls of buildings and vehicle doors, require for example door frames and bodies as well as wall frames and bodies that have increased thickness and supporting structures. Such structures easily ruin the desired look of a glass wall and/or door as they often extend to both inside and outside of the glass wall and/or door or the method used to attach them is easily apparent above or beneath the glass surface.

The aspects of the embodiments disclosed aim to mitigate the disadvantages of the prior art by providing a soundproof glass door and/or wall structure that also ensures the esthetically pleasing qualities thereof.

### SUMMARY

Various aspects of examples of the aspects of the disclosed embodiments are set out in the claims.

According to a first example aspect of the aspects of the disclosed embodiments, there is provided a structure, comprising
a body element;
a surface plate attached to the body element, wherein the surface element comprises a substantially transparent material;
wherein the surface plate comprises on a portion thereof contacting the body element a colored surface layer.

The transparent material may comprise glass, acrylic glass or polycarbonate.

The colored surface layer may have a substantially dark color.

The colored surface layer may be a silk-screen printed or digitally printed layer.

The structure may further comprise an attachment layer through which the body element and the surface plate are attached and in contact.

The body element may be a body element configured to provide for soundproofing.

The body element may be a doorframe.

According to a second example of the aspects of the disclosed embodiments, there is provided a comprising the structure of the first example aspect.

According to a third example of the aspects of the disclosed embodiments, there is provided a door comprising the structure the first example aspect.

According to a fourth example of the aspects of the disclosed embodiments, there is provided a system, characterized by comprising the wall of the second example aspect and the door of the third example aspect.

The system may further comprise hinges supporting the door on a doorframe.

The system may further comprise a sealing element for sealing the gap between the door and the wall.

According to a fifth example of the aspects of the disclosed embodiments, there is provided a phone booth, comprising the wall of the second example aspect, the door of the third example aspect or the system of the fourth example aspect.

According to a sixth example of the aspects of the disclosed embodiments, there is provided a method of manufacturing the structure, the wall, the door, or the system of previous aspects by
providing a colored surface layer on a portion of a surface plate comprising transparent material; and
attaching the surface plate on a body element in such a way that the portion of the surface plate comprising the surface layer is in contact with the body element.

Providing the colored surface layer may comprise silk-screen or digital printing.

Different non-binding example aspects and embodiments of the present disclosure have been illustrated in the foregoing. The embodiments in the foregoing are used merely to explain selected aspects or steps that may be utilized in implementations of the present disclosure. Some embodiments may be presented only with reference to certain example aspects of the present disclosure. It should be appreciated that corresponding embodiments may apply to other example aspects as well.

### BRIEF DESCRIPTION OF THE DRAWINGS

For a more complete understanding of example embodiments of the present disclosure, reference is now made to the following descriptions taken in connection with the accompanying drawings in which:

FIG. 1 shows a schematic view of a wall with a door and/or wall structure according to an embodiment of the invention;

FIG. 2 shows a schematic view of a cross section of a structure with a door and/or wall structure according to an embodiment of the invention along section A-A;

FIG. 3 shows an enlarged schematic view of section B of a door and wall structure according to an embodiment of the invention; and

FIG. 4 shows a flow chart of a method of manufacturing a door and/or wall structure according to an embodiment of the invention.

### DETAILED DESCRIPTION OF THE DRAWINGS

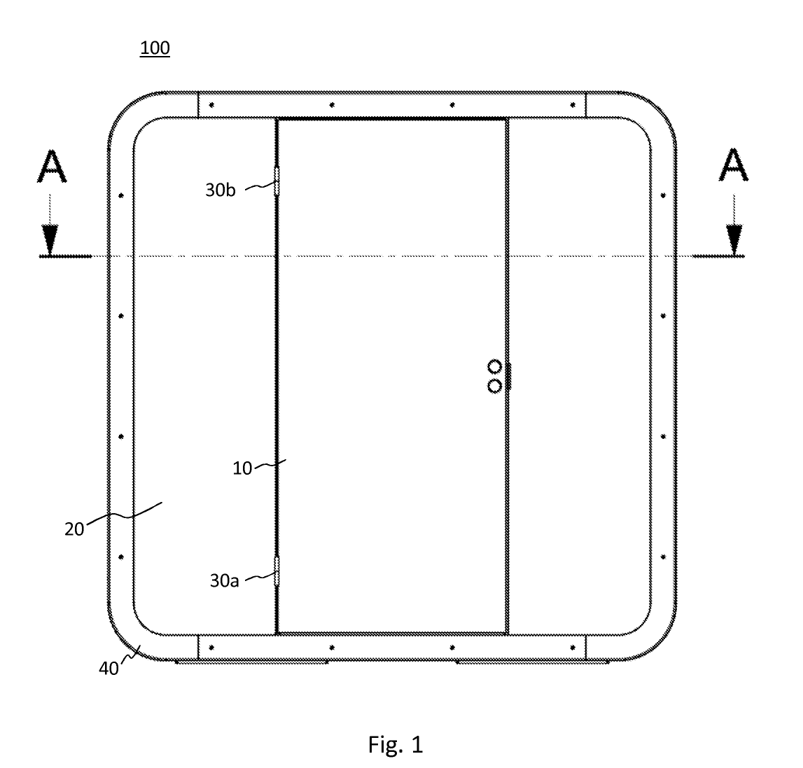

The aspects of the disclosed embodiments and its potential advantages are understood by referring to FIGS. 1 through 4 of the drawings. In this document, like reference signs denote like parts or steps.

FIG. 1 shows a schematic view of a wall with a door and/or wall structure according to an embodiment of the present disclosure. The wall 100 comprises a door 10 substantially level with a wall 20. In an embodiment, the wall surface and/or the door surface comprise glass. The door 10 is supported by hinges 30a,30b. The wall structure, in an embodiment, further comprises a frame 40 configured to surround and/or support the wall 20. In an embodiment, the frame comprises material such as wood, metal, plastic, composite or a combination thereof.

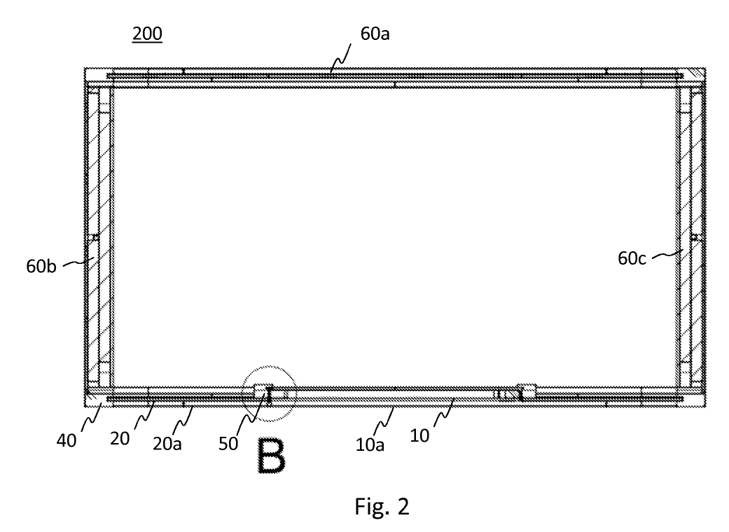

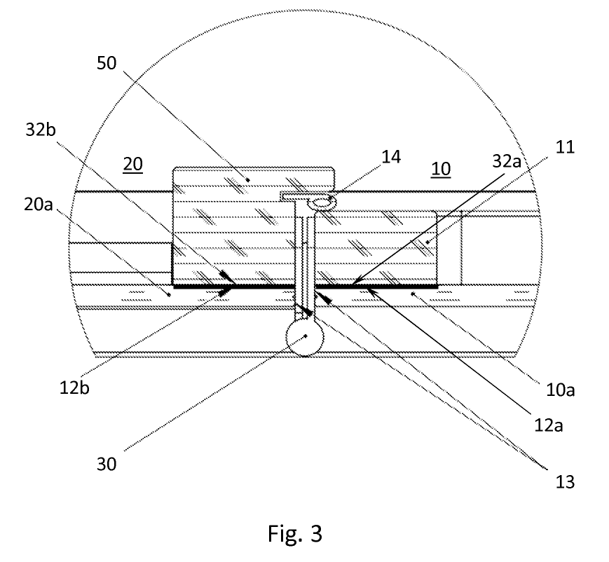

FIG. 2 shows a schematic view of a cross section of a structure 200 with a door and/or wall structure according to an embodiment of the present disclosure along section A-A of FIG. 1. In an embodiment, the structure 200 comprises a phone booth, conference space or a room. FIG. 2 shows the door 10, supported by hinges (not shown in FIG. 2) on a wall body element, such as a doorframe 50. In an embodiment, the doorframe 50 comprises material such as wood or metal. In order for the door 10 to be soundproof, more rigid, and sturdy and to enable the use of various types of hinges, the door comprises in addition to the door surface plate 10a internal structures adding thickness as hereinafter described with reference to FIG. 3. In an embodiment, the door surface plate comprises glass.

FIG. 2 further shows the wall 20 in which the door 10 is positioned. The wall 20 comprises internal structures for example for soundproofing, and a wall surface plate 20a level with the door surface plate 10a of the door 10. In an embodiment, the wall surface plate 20a comprises glass. The wall 20 is, in an embodiment, supported by the frame 40. The structure 200 further comprises sidewalls 60b,60c and a back wall 60a.

In an embodiment, the glass of which the door surface plate 10a and/or the wall surface plate 20a are comprised of is transparent and colorless. In a further embodiment, the glass of which the door surface plate 10a and/or the wall surface plate 20a are comprised of is colored or tinted and transparent. In a further embodiment, the glass of which the door surface plate 10a and/or the wall surface plate 20a are comprised of has a reduced transparency or is opaque, for example the glass comprises frosted glass. In a further embodiment, the door surface plate 10a and/or the wall surface plate 20a comprise material having properties substantially similar to glass such as acrylic glass or polycarbonate.

FIG. 3 shows an enlarged schematic view of section B (FIG. 2) of a door and wall structure according to an embodiment of the present disclosure. FIG. 3 shows the door 10 comprising the door surface plate 10a and a door body element 11. The door body element is configured to provide for soundproofing, sturdiness, rigidity and enable the use of hinges. FIG. 3 further shows the wall 20 with the wall surface plate 20a. In the embodiment of FIG. 3, the door surface plate 10a and the wall surface plate 20a comprise glass. The glass wall surface plate 20a is attached to a wall body element, such as the doorframe 50 by gluing or a similar method with an attachment layer 32b between the doorframe 50 and the wall surface plate 20a. Similarly, the glass door surface plate 10a is attached to the door body element 11 by gluing or a similar method with an attachment layer 32a between the door body element 11 and the glass door surface plate 10a.

FIG. 3 further shows a hinge 30 and softening elements 13 between the hinge and the wall surface plate and the glass door surface plate 10a, respectively. Furthermore, a sealing element 14 configured to seal the gap between the door 10 and the doorframe 50, i.e. the gap between the door 10 and the wall 20. In an embodiment, the seal element 14 comprises an element with an o-formed main portion.

The glass door surface plate 10a further comprises a surface layer 12a on the part of the back surface thereof facing the door body element 11 and the attachment layer 32a. The surface layer 12a comprises a colored layer configured to cover the portion of the back surface in contact with the attachment layer 32a and the door body element 11. In an embodiment, the surface layer 12a comprises a silk-screen, or serigraph, printed layer. In a further embodiment, the surface layer 12a comprises a digitally printed layer. In an embodiment, the surface layer 12a comprises a layer having a dark color, such as black. The surface layer 12a is configured to cover the portion of the glass door surface plate 10a facing the door body element 11 and configured to cause, when the door 10 is observed from the side opposite to the surface layer 12a, an appearance of a substantially continuous glass surface. In an embodiment, the appearance of a substantially continuous glass surface is further emphasized by reflections or reflective features of the glass door surface plate 10a.

The glass wall surface plate 20a further comprises a surface layer 12b on the part of the back surface thereof facing the doorframe 50 and the attachment layer 32b. The surface layer 12b comprises a colored layer configured to cover the portion of the back surface in contact with the attachment layer 32b and the doorframe 50. In an embodiment, the surface layer 12b comprises a silk-screen, or serigraph, printed layer. In a further embodiment, the surface layer 12b comprises a digitally printed layer. In an embodiment, the surface layer 12b comprises a layer having a dark color, such as black. The surface layer 12b is configured to cover the portion of the glass wall surface plate 20a facing the doorframe 50 and configured to cause, when the wall 20 is observed from the side opposite to the surface layer 12b, an appearance of a substantially continuous glass surface. In an embodiment, the appearance of a substantially continuous glass surface is further emphasized by reflections or reflective features of the glass wall surface plate 20a.

In a still further embodiment, the appearance of a substantially continuous glass surface is further aided by choosing the colors of the structures of the space behind the wall and the door in such a way as to strengthen the effect, for example by providing the space, i.e. room, behind the wall 20 and the door 10 with interior surfaces having a dark color.

In an embodiment with both the wall surface plate 20a and the door surface plate 10a comprising glass, the surface layers 12a,12b are configured to cover the underlying structures such as the door body element 11 and the doorframe 50 and are configured to cause an appearance of a substantially continuous glass surface across the door 10 and the wall 20. Furthermore, in an embodiment, similar surface layers are applied to cover further body elements, or structures, such as support beams or the like. In a further embodiment, instead of both the wall and the door having a substantially transparent, e.g. glass surface palate, only either one of them has a substantially transparent surface plate.

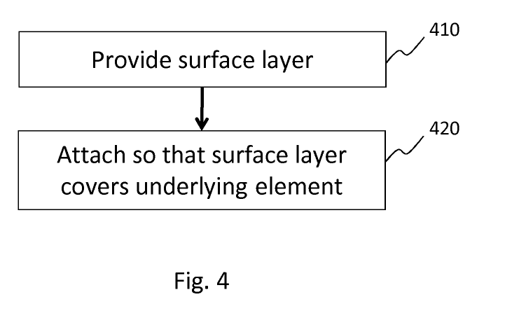

FIG. 4 shows a flow chart of a method of manufacturing a door and/or wall structure according to an embodiment of the invention. At 410, the surface layer 12a,12b is provided on the backside of the glass door surface plate 10a and/or the glass wall surface plate 20a. In an embodiment, the surface layer 12a,12b is silk-screen, or serigraph, or digitally printed. In a further embodiment, the colored surface layer 12a,12b is provided by sandblasting the surface and darkening it with a desired color. At 420, the glass door surface plate 10a and/or the glass wall surface plate 20a is attached to the underlying structures, such as the doorframe 50 and the door body element 11 for example by gluing. The attachment is carried out in such a way that the surface layer 12a.12b covers the portions on which the glass door surface plate 10a and/or the glass wall surface plate 20a are in contact with the underlying structures and the attachment layer 32a,32b.

Without in any way limiting the scope, interpretation, or application of the claims appearing below, a technical effect of one or more of the example embodiments disclosed herein is providing a soundproofed glass wall and/or door with an appearance of continuous glass surface. Another technical effect of one or more of the example embodiments disclosed herein is providing an easy installment of a soundproof glass surface.

Although various aspects of the present disclosure are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the present disclosure, these descriptions should not be viewed in a limiting sense. Rather, there are several variations and modifications which may be made without departing from the scope of the present disclosure as defined in the appended claims.

1. A structure, comprising:
a body element; and
a surface plate attached to the body element, wherein the surface element comprises a substantially transparent material;
wherein the surface plate comprises, on a portion thereof contacting the body element, a colored surface layer.

2. The structure of claim 1, wherein the transparent material comprises one or more of glass, acrylic glass or polycarbonate.

3. The structure of claim 1, wherein the colored surface layer has a substantially dark color.

4. The structure of claim 1, wherein the colored surface layer is a silk-screen printed or digitally printed layer.

5. The structure of claim 1, further comprising an attachment layer through which the body element and the surface plate are attached and in contact.

6. The structure of claim 1, wherein the body element is configured to provide soundproofing.

7. The structure of claim 1, wherein the body element is a doorframe.

8. The structure according to claim 1, wherein the structure is a wall.

9. The structure according to claim 1, wherein the structure is a door.

10. A system, comprising a wall and a door, wherein the wall comprises:
a first body element;
a first surface plate attached to the first body element, wherein the first surface element comprises a substantially transparent material, and further comprises, on a portion thereof contacting the first body element, a first colored surface layer; and
wherein the door comprises:
a second body element;
a second surface plate attached to the second body element, wherein the second surface element comprises a substantially transparent material and further comprises, on a portion thereof contacting, the first body element a first colored surface layer.

11. The system of claim 10, further comprising hinges supporting the door on a doorframe.

12. The system of claim 10, further comprising a sealing element for sealing the gap between the door and the wall.

13. The system according to claim 10, wherein the system is a phone booth.

14. A method of manufacturing a structure the structure comprising a body element and a surface plate attached to the body element, the method comprising:
providing a colored surface layer on a portion of the surface plate comprising a transparent material; and
attaching the surface plate on the body element such that the portion of the surface plate comprising the colored surface layer is in contact with the body element.

15. The method of claim 14, wherein providing the colored surface layer comprises silk-screen or digital printing.
